(19) United States
(12) Patent Application Publication
(10) Pub. No.: US 2017/0108275 A1
(43) Pub. Date: Apr. 20, 2017

(54) Process and system for waste heat grading cyclic utilization and pollutant emission reduction of sintering flue gas

(71) Applicants: INSTTUTE OF PROCESS ENGINEERING, CHINESE ACADEMY OF SCIENCES, Beijing (CN); Beijing KBSC Environmental Engineering Co., Ltd., Beijing (CN)

(72) Inventors: Tingyu ZHU, Beijing (CN); Wenqing XU, Beijing (CN); Bin WAN, Beijing (CN); Yunfa CHEN, Beijing (CN)

(21) Appl. No.: 15/123,187

(22) PCT Filed: Sep. 22, 2015
(86) PCT No.: PCT/CN2015/090218

§ 371 Date: Sep. 1, 2016

(30) Foreign Application Priority Data
Mar. 27, 2015 (CN) 201510140855.9

(51) Int. Cl. F27D 17/00; B01D 53/50; B01D 53/34; B22F 3/00; B22F 3/10

(52) U.S. Cl. CPC F27D 17/008; B22F 3/003; B22F 3/10; F27D 17/004; B01D 53/346; B01D 53/50; B01D 53/343; B22F 2201/50

(57) ABSTRACT

The present invention provides a process and system for waste heat grading cyclic utilization and pollutant emission reduction of sintering flue gas, in which the sintering flue gas is divided into low-temperature, high-oxygen, low-humidity section sintering flue gas; middle-temperature, low-oxygen, high-humidity section sintering flue gas; and high-temperature, high-oxygen, low-humidity section sintering flue gas according to the emission characteristics of temperature, oxygen content and humidity of the flue gas. The low-temperature, high-oxygen, low-humidity section sintering flue gas is led into the sintering machine for hot air ignition and hot air sintering; the middle-temperature, low-oxygen, high-humidity section sintering flue gas is subjected to dust removal and desulfurization treatments; the high-temperature, high-oxygen, low-humidity section sintering flue gas is mixed with exhaust gas of a cooler and then is led into the sintering machine for hot air sintering. The present invention can conduct grading utilization to the flue gas and recycle low-temperature sensible heat in flue gas, making the carbon monoxide left in the sintering flue gas burn again and thus saving energy consumption in the sintering process, on the premise that the quality and yield of the sintered ores are ensured. The present invention can also conduct cyclic utilization to the flue gas and thereby reduce pollutant emissions and the total emissions of sintering flue gas per unit of the sintered ores. Thus, the present invention has a very high value on energy saving and emission reduction.

### TECHNICAL FIELD

The present invention belongs to the field of sintering production technology in metallurgy industry, and relates to a process and system for waste heat grading cyclic utilization of sintering flue gas, in particular to a process and system for waste heat grading cyclic utilization and pollutant emission reduction of sintering flue gas, more particularly to a process and system for waste heat grading cyclic utilization and pollutant emission reduction of sintering flue gas, based on different temperatures, oxygen concentrations and humidity emission characteristics of flue gas.

### BACKGROUND ART

Iron and steel industry is a highly polluting industry. A large amount of flue gas is produced during the sintering production process of iron ore. For example, when a sintering machine of 495 m² is working in normal production, the emission amount of flue gas is up to 1.2 million standard cubic meters per hour (Nm³/h) or more. In addition, since domestic sintering machines have a high air leakage rate (40-50%) and high solids circulation rate, a considerable part of air does not pass the sintering layer, producing about 4000-6000 m³ of flue gas when 1 ton of sintered ores are produced. Sintering flue gas has main characteristics of large amounts of flue gas, high temperature, large amounts of dust taking along, high CO content, low sulfur dioxide (SO₂) concentration, high moisture content, and containing corrosive gases and dioxin substances, etc. Since the emission sources of sintering flue gas are centralized and the total emission amount thereof is large, sintering flue gas has a large influence on the atmospheric quality in some areas and may cause serious environmental pollution. Thus, it is necessary to carry out pollutant purification of sintering flue gas to achieve the effect of environmental protection and emission reduction.

Energy consumption for sintering steel accounts for about 8-10% of the total energy consumption of steel production, only second to ironmaking. Sintering steel is the second largest energy consumer in steel production, wherein 52% of heat is discharged into the atmosphere from the main flue of the sintering machine (24%) and cooler (28%) as sensible heat. According to statistics, in China, the utilization rate of waste heat from the sintering process is less than 30%, and the utilization rate of the sintering flue gas is essentially zero. About 80% of the heat source in the sintering process comes from solid fuel combustion, however, the current sintering process in China is on average 20 kg of standard coal/ton (kgce/t) larger than the foreign advanced level, and the gap is even greater in small and middle steel plants, which is about 25 kgce/t higher. In addition, gaps between domestic and foreign plants are also relatively large. Therefore, China has a great potential for energy-saving sintering, and achieving energy-saving and consumption-reducing in the sintering process is of great significance on reducing the energy consumption per ton steel in steel production and saving production cost. Therefore, reducing the consumption of solid fuel and utilizing sensible heat of flue gas become the main direction to reduce the energy consumption in the sintering process.

The sintering process is an oxidation process on the whole, and oxygen is used not only to support fuel combustion, but also to support the mineralization of sintered ore. When the oxygen content of the circulating flue gas is less than 18%, the physical and chemical indexes of the sintered ore are decreased sharply. Thus, the oxygen content in the circulating flue gas must be ensured. However, during the combustion process of the sintering mixture, the water contained therein is completely removed and comes into the sintering flue gas in the form of water vapor. The content of the water vapor will affect the physical and chemical indexes of the sintered ore. When the content of the water vapor is higher than 8%, each index of the sintered ore will decrease.

The utilization of the sintering flue gas waste heat is mainly divided into the following ways: (1) recycling the sintering flue gas and using the recycled sintering flue gas as air for ignition and holding furnace combustion in order to save gas consumption; (2) carrying out hot air sintering to improve the sintering quality; (3) using a waste heat boiler to recycle the waste heat of flue gas to produce steam: the steam in one hand can be used to preheat a mixture of materials, which cannot only reduce solid fuel consumption but also reduce the over-wet phenomenon during the sintering process; in another hand, the steam can be used to generate electricity by steam turbines.

In CN 101893384A, air with high temperature was segment collected by sintering flue gas, mixed with the exhaust gas of the cooler, introduced into the hot air cover in the sintering machine, and participated in hot air sintering. The invention is advantageous to the full combustion of the fuel in the sintered ore, and can improve the quality of the sintered ore and save solid fuel. But the sintering flue gas is not utilized by grading, and the utilization rate of waste heat of the sintering flue gas is low. In addition, the effects of the oxygen content and humidity in circulating flue gas on the quality and yield of the sintered ore are not considered. In CN 101024143, a circulation is carried out by taking a part of the flue gas from the main flue of the sintering machine to return to the seal cover in the upper part of the sintering machine, along with supplying oxygen required by the combustion in the sintering machine, and the remaining part of the flue gas is discharged after the desulfurization treatment. In this invention, the circulating flue gas has a high oxygen content, which is beneficial to the full combustion of the fuel in the sintered ore. But the utilization rate of waste heat of the sintering flue gas is low, and the influence of the humidity in the flue gas on the sintered ore is not considered. In CN 101832572B, flue gas is drawn out by a bellows at the end of the main flue of the sintering machine, and is discharged after heat exchange by a waste heat boiler and after desulfurization and dust removal. This invention saves a draught fan, and introduces the flue gas to exchange heat through pressure difference, but does not achieve the effect of the pollutant emission reduction. In CN 104132550A, the main flue of the sintering machine is divided into three sections, and the flue gas in the high-temperature middle-sulfur section is taken to return to the seal cover of the trolley of the sintering machine to circulate, along with supplying oxygen required by the combustion in the sintering machine. This invention achieves the purpose of energy saving and emission reduction through flue gas circulation, and is convenient for desulfurization of sintering flue gas, but the circulation amount of waste gas is small, the energy saving and emission reduction effect is low, and the influence of the flue gas humidity on the production of the sintered ore is not considered.

### CONTENTS OF THE INVENTION

In view of the above problems, the present invention studied heat distribution in the sintering process, and taking into account the influences of the oxygen content and humidity of the sintering flue gas on the sintered ore, the waste heat of the sintering flue gas was grade recycled, and the sintering flue gas was circulated and used mixed with part of the exhaust gas of coolers, thereby obtaining a waste heat utilization technology for steel plants achieving energy saving and emission reduction.

Accordingly, in view of the existing technical problems, the purpose of the present invention is to provide a process and system for waste heat utilization and pollutant emission reduction of the sintering flue gas, which cannot only increase waste heat grading utilization but also reduce the total amount of pollutants and control concentration thereof, under the premise of guaranteeing the quality and yield of the sintered ore.

To achieve the above purpose, the present invention employs the following technical solution.

A process for waste heat grading cyclic utilization and pollutant emission reduction of the sintering flue gas, in which the sintering flue gas in each of the bellows in the main flues of a sintering machine is divided into low-temperature, high-oxygen, low-humidity section sintering flue gas; middle-temperature, low-oxygen, high-humidity section sintering flue gas; and high-temperature, high-oxygen, low-humidity section sintering flue gas according to the emission characteristics of temperature, oxygen content and humidity of the flue gas; wherein the low-temperature, high-oxygen, low-humidity section sintering flue gas is led into a sintering machine for hot air ignition and hot air sintering; the middle-temperature, low-oxygen, high-humidity section sintering flue gas is discharged after desulfurization treatment; the high-temperature, high-oxygen, low-humidity section sintering flue gas is mixed with exhaust gas of a cooler and then is led into the sintering machine for hot air sintering.

By calculating each heat income and expenditure during the sintering process and establishing a CFD dynamic heat transfer model, the present invention adjusts the ratio of sintering raw materials, fabric thickness, throttle opening of the air exhauster and operating speed of the sintering machine, and the temperature, oxygen and humidity distributions of the sintering flue gas in the sintering machine are adjusted, and further the low-temperature, high-oxygen, low-humidity section sintering flue gas, middle-temperature, low-oxygen, high-humidity section sintering flue gas and high-temperature, high-oxygen, low-humidity section sintering flue gas are specifically adjusted, then the flue gas from bellows is led out and coupling emission in the sintering flue gas area of the sintering machine is carried out, achieving the purpose of energy saving and emission reduction.

With respect to specific implementation thereof, by adjusting the ratio of sintering raw materials, fabric thickness, throttle opening of the air exhauster, operating speed of the sintering machine, the present invention adjusts gas permeability of the sintering layer and high temperature holding time, and supplements heat for waste heat utilization of the sintering layer and changes heat distribution; thereby adjusts temperature, oxygen and humidity distributions of the sintering flue gas in the sintering machine; and divides the sintering flue gas into three sections: low-temperature, high-oxygen, low-humidity section, middle-temperature, low-oxygen, high-humidity section and high-temperature, high-oxygen, low-humidity section according to the distribution characteristics of temperature, oxygen content and humidity; and then carries out grading treatment to the sintering flue gas.

The cyclic utilization of the sintering flue gas not only supplements heat to the sintered ore, but also makes unburned carbon monoxide burn again. Meanwhile, the sintering flue gas coming into the sintering machine makes dioxin crack at high temperature, achieving pollutant purification. In addition, high temperature can also reduce the emission amount of nitrogen oxides. Grading utilization of the sintering flue gas waste heat not only saves fuel, but also reduces the emission amount of pollutants per sintered ore unit during the sintering process.

Preferably, the low-temperature, high-oxygen, low-humidity section sintering flue gas is led into the sintering machine after dust removal treatment, for hot air ignition and hot air sintering.

Preferably, the middle-temperature, low-oxygen, high-humidity section sintering flue gas is discharged after dust removal and desulfurization treatment and SO₂ content thereof meeting the national emission standards.

Preferably, the high-temperature, high-oxygen, low-humidity section sintering flue gas is mixed with exhaust gas of the cooler after dust removal treatment.

In the present invention, the flue gas in the bellows at the head and tail parts of the main flue (i.e. those around burning through point) is drawn out, and circulated to sintering material layer of sintering trolley after mixing with cooling flue gas drawn from the sintering cooler in the mixing chamber, achieving full utilization of waste heat of sintering flue gas.

In addition, the oxygen concentration and humidity of the sintering flue gas in the sintering machine can be adjusted by the above process, ensuring the quality and yield of sintered ore.

Preferably, the temperature of the low-temperature, high-oxygen, low-humidity section sintering flue gas is 50-100° C., for example, 55° C., 60° C., 65° C., 70° C., 75° C., 80° C., 85° C., 90° C. or 95° C.; the temperature of the middle-temperature, low-oxygen, high-humidity section sintering flue gas is 100-250° C., for example, 110° C., 120° C., 130° C., 140° C., 150° C., 160° C., 170° C., 180° C., 190° C., 200° C., 210° C., 220° C., 230° C. or 240° C.; and the temperature of the high-temperature, high-oxygen, low-humidity section sintering flue gas is 250-350° C., for example, 260° C., 270° C., 280° C., 290° C., 300° C., 310° C., 320° C., 330° C. or 340° C.

Preferably, the oxygen content of the low-temperature, high-oxygen, low-humidity section sintering flue gas is 18-21%, for example, 18.2%, 18.4%, 18.6%, 18.8%, 19%, 19.2%, 19.4%, 19.6%, 19.8%, 20%, 20.2%, 20.4%, 20.6%, 20.8%, 21%, 21.2%, 21.4%, 21.6% or 21.8%; the oxygen content of the middle-temperature, low-oxygen, high-humidity section sintering flue gas is 11-15%, for example, 11.2%, 11.4%, 11.6%, 11.8%, 12%, 12.2%, 12.4%, 12.6%, 12.8%, 13%, 13.2%, 13.4%, 13.6%, 13.8%, 14%, 14.2%, 14.4%, 14.6% or 14.8%; and the oxygen content of the high-temperature, high-oxygen, low-humidity section sintering flue gas is 18-21%, for example, 18.2%, 18.4%, 18.6%, 18.8%, 19%, 19.2%, 19.4%, 19.6%, 19.8%, 20%, 20.2%, 20.4%, 20.6%, 20.8%, 21%, 21.2%, 21.4%, 21.6% or 21.8%.

Preferably, the humidity of the low-temperature, high-oxygen, low-humidity section sintering flue gas is 0-4%, for example, 0.3%, 0.6%, 0.9%, 1.2%, 1.5%, 1.8%, 2.1%, 2.4%, 2.7%, 3%, 3.3%, 3.6% or 3.9%; the humidity of the middle-temperature, low-oxygen, high-humidity section sintering flue gas is 4-10%, for example, 4.5%, 5%, 5.5%, 6%, 6.5%, 7%, 7.5%, 8%, 8.5%, 9% or 9.5%; and the humidity of the high-temperature, high-oxygen, low-humidity section sintering flue gas is 0-4%, for example, 0.3%, 0.6%, 0.9%, 1.2%, 1.5%, 1.8%, 2.1%, 2.4%, 2.7%, 3%, 3.3%, 3.6% or 3.9%.

Preferably, in order to maximize the use of waste heat resources, the exhaust gas (i.e., middle-temperature section exhaust gas (the temperature thereof is about 250° C.) of cooler) of the cooler mixed with the high-temperature, high-oxygen, low-humidity section sintering flue gas represents 25-35% by volume of the total amount of the exhaust gas of the cooler, for example, 25.2-29%, 26-31%, 29.5-32.4%, 30.0% by volume etc.

Preferably, in order to maximize the use of waste heat resources, the high-temperature, high-oxygen, low-humidity section sintering flue gas introduced into the sintering machine represents 15-25% by volume of the total amount of the sintering flue gas, for example, 15.3-18.5%, 17-23%, 20.5-22%, 23.0% by volume etc. The high-temperature, high-oxygen, low-humidity section sintering flue gas locates in the bellows around the burning through the point of the sintering machine, and represents about ⅙-¼ of the amount of the flue gas in the total bellows.

Preferably, in order to maximize the use of waste heat resources and save the cost for running pollution control facilities, the low-temperature, high-oxygen, low-humidity section sintering flue gas introduced into the sintering machine represents 15-25% by volume of the total amount of the sintering flue gas, for example, 15.3-18.5%, 17-23%, 20.5-22%, 23.0% by volume etc. The low-temperature, high-oxygen, low-humidity section flue gas locates in ignition and temperature-holding sections of the head of the sintering machine, and represents about ⅕ of the amount of the flue gas in the total bellows.

The total amount of the sintering flue gas refers to the sum of the volume of all sintering flue gas in each of the bellows in the main flue of the sintering machine.

The present invention also provides a system for achieving the process as described above, comprising a sintering machine, the bellows of which are divided into low-temperature, high-oxygen, low-humidity section bellows, middle-temperature, low-oxygen, high-humidity section bellows and high-temperature, high-oxygen, low-humidity section bellows, wherein the low-temperature, high-oxygen, low-humidity section bellows are connected to an ignition furnace of the sintering machine and a sealing hot air cover of the sintering machine respectively; the middle-temperature, low-oxygen, high-humidity section bellows are connected to a desulfurization device; and the high-temperature, high-oxygen, low-humidity section bellows are connected to the sealing hot air cover of the sintering machine through a mixing chamber which is further connected to a cooler.

Preferably, the low-temperature, high-oxygen, low-humidity section bellows are connected to the ignition furnace of the sintering machine and the sealing hot air cover of the sintering machine respectively after being connected to a dust removal device.

Preferably, the middle-temperature, low-oxygen, high-humidity section bellows are connected to a desulfurization device and a chimney successively after being connected to a dust removal device.

Preferably, the high-temperature, high-oxygen, low-humidity section bellows are connected to a mixing chamber after being connected to a dust removal device.

The dust removal device of the present invention is used to remove larger particles in the sintering flue gas. Preferably, the dust removal device is any one of a cyclone deduster, a bag filter or an electric bag filter, or a combination of at least two of them.

Preferably, the desulfurization device is any one of a circulating fluidized bed semi-dry desulfurization device, a SDA desulfurization device or a wet desulfurization device, or a combination of at least two of them.

Preferably, a hood is respectively set at both the head and tail of the sintering machine. The hoods are capable of sealing the sintering flue gas, and the sealing mode is a negative pressure labyrinth seal.

The present invention carries out a grading cyclic utilization to the sintering flue gas, according to emission characteristics of temperature, oxygen content and humidity of the flue gas, to ensure that the quality and yield of sintered ore are not affected, and to reduce the total pollutant emissions. In addition, the recovery efficiency of the sintering low-temperature waste heat is improved by reasonably arranging the sintering flue gas circulation system and carrying out grading recycle and cascade utilization to sintering flue gas according to the quality and thermal characteristics of the heat waste of different temperature ranges. The technology of the present invention realizes energy saving and environmental protection, and can realize the waste heat utilization of sintering flue gas and the control of flue gas emission reduction.

The technology of the present invention achieves regional coupled emission of the sintering machine by adjusting the thermodynamic parameters and operating conditions and carrying out a modular operation, and has the following advantages compared with the traditional waste heat utilization technology:

1. The utilization efficiency of waste heat is reasonably improved by regulating the heat supply, changing the holding time of the high-temperature section of the sintering layer, adjusting the coupling distribution of oxygen concentration, humidity and temperature in each of the bellows of the sintering machine, and carrying out block utilization to the waste heat. The impact of oxygen content and humidity on the sintered ore is taken into account to ensure oxygen content and water content in the circulating flue gas, and to reduce the use of the air supply fan.

2. The process energy consumption can be reduced and the sintering process energy consumption can be reduced by around 8% (about 4.5-5 kgce/t-s) by circulating the sintering flue gas, carrying out hot air ignition and hot air sintering, with carbon monoxide burning again.

3. The sintering flue gas is circulated into the sintering machine, and can crack dioxin at high temperature. After catalytic absorption of nitrogen oxides, the concentration of dioxin-type substances decreases by more than 30%, and the total amount of flue gas emissions decreases by more than 20%, which is favorable for environmental protection.

4. When it is applied to a sintering machine which is not equipped with a waste heat boiler, the energy saving effect would be more significant and the investment of the waste heat boiler equipment can also be saved.

5. The total amount of the flue gas is reduced significantly, which can significantly reduce the load of the sintering electric deduster and the desulfurization equipment, and reduce the operating cost of the environmental protection facilities.

### DESCRIPTION OF THE DRAWINGS

FIG. 1 is a system diagram of Example 1 of the present invention.

FIG. 2 is a variation diagram of the temperature and humidity of the sintering flue gas along the length of the sintering machine according to the present invention.

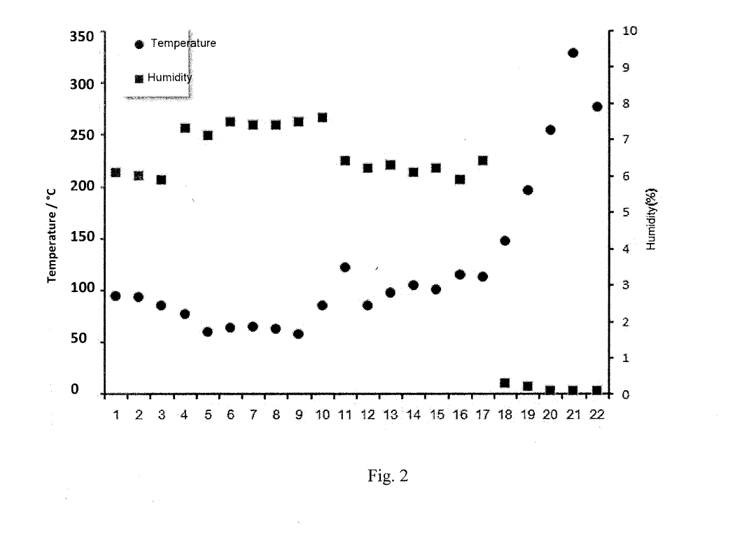

FIG. 3 is a variation diagram of the temperature of the sintering flue gas and the O₂ concentration along the length of the sintering machine according to the present invention.

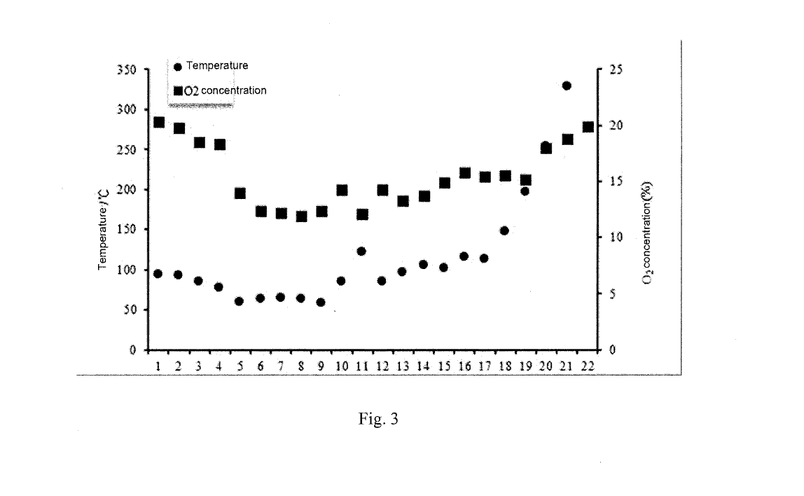

### REFERENCE NUMBERS

1—sintering machine; 2—ignition furnace; 3—hood; 4—sealing hot air cover; 5—draught fan; 6—mixing chamber; 7—cooler; 8—dust removal device; 9—desulfurization device; 10—chimney; \textcircled{1}˜\textcircled{4}—low-temperature, high-oxygen, low-humidity section bellows; \textcircled{5}˜\textcircled{18}—middle-temperature, low-oxygen, high-humidity section bellows; \textcircled{19}˜\textcircled{22}—high-temperature, high-oxygen, low-humidity section bellows.

### DETAILED DESCRIPTION

The present invention is further described by the following non-limiting embodiments in the detailed description along with the figures.

### EXAMPLES

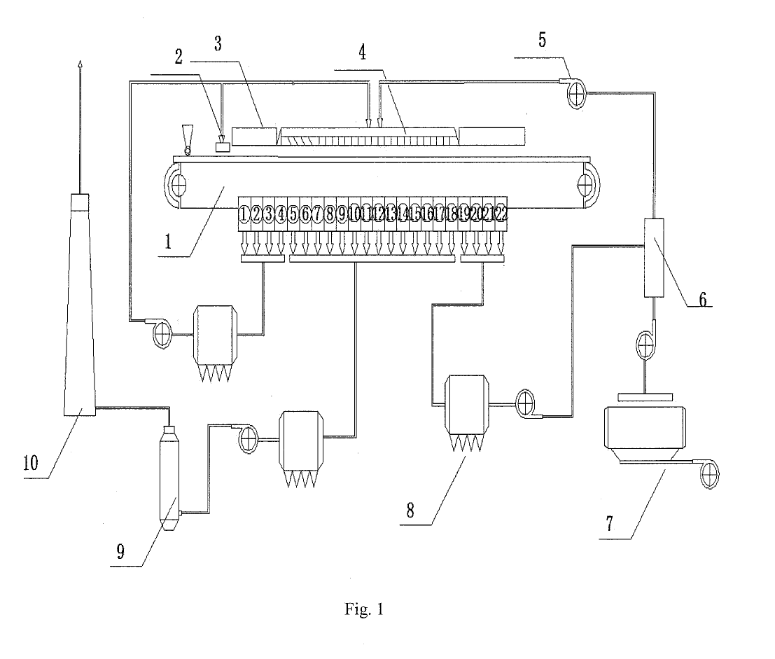

As shown in FIG. 1, the system comprises a sintering machine 1, \textcircled{1}˜\textcircled{4} represent low-temperature, high-oxygen, low-humidity section bellows, \textcircled{5}˜\textcircled{18} represent middle-temperature, low-oxygen, high-humidity section bellows, and \textcircled{19}˜\textcircled{22} represent high-temperature, high-oxygen, low-humidity section bellows. Wherein, the low-temperature, high-oxygen, low-humidity section bellows \textcircled{1}˜\textcircled{4} are connected to an ignition furnace 2 of the sintering machine 1 and a sealing hot air cover 4 of the sintering machine 1 respectively after being connected to a dust removal device; the middle-temperature, low-oxygen, high-humidity section bellows \textcircled{5}˜\textcircled{18} are connected to a desulfurization device 9 and a chimney 10 successively after being connected to a dust removal device; and the high-temperature, high-oxygen, low-humidity section bellows \textcircled{19}˜\textcircled{22} are connected to the sealing hot air cover 4 of the sintering machine 1 through a mixing chamber 6 which is further connected to a cooler 7 after being connected to a dust removal device 8.

As shown in FIG. 1, on a sintering machine 1 having an area of 200 m², which is equipped with a main exhaust blower having a main exhaust volume of 1 million m³/hr, the sintering flue gas (250-350° C., 180 thousand m³/hr) in the high-temperature, high-oxygen, low-humidity section bellows \textcircled{19}˜\textcircled{22} at the tail of the sintering machine is drawn out through a circulating pipeline, and led back through a dust removal device 8 and a draught fan, introduced into a mixing chamber 6 and mixed with the exhaust gas (180 thousand m³/hr, 200° C.) which is from a cooler 7 and drawn out by a draught fan, and then circulated to a sealing hot air cover 4 of the sintering machine 1; the sintering flue gas (50-100° C., 180 thousand m³/hr) in the low-temperature, high-oxygen, low-humidity section bellows \textcircled{1}˜\textcircled{4} at the head of the sintering machine is drawn out through a circulating pipeline, and led back through a dust removal device and a draught fan, and then circulated to an ignition furnace 2 and a sealing hot air cover 4 of the sintering machine 1 for reuse; the sintering flue gas in the middle-temperature, low-oxygen, high-humidity section bellows \textcircled{5}˜\textcircled{18} at the middle of the sintering machine is drawn out through a circulating pipeline, and led back through a dust removal device and a draught fan, and subjected to desulfurization through a desulfurization device 9, and then discharged through a chimney 10.

This example can reduce the total amount of the flue gas discharged by the main exhaust blower of the sintering machine by 20% or more, and reduce the emission of exhaust gas of the cooler by 30%, and save energy 4.5-5 kgce/t-s per ton of the sintered ore.

The above examples explain the implementation idea of the present invention, and are not the only structural characteristics and means. The present invention is not limited to the above detailed structural characteristics and means; that is to say, it does not mean that the present invention must rely on the above detailed structural characteristics and means to be implemented. Those skilled in the art to which the present invention belongs should appreciate that any improvement to the present invention, equivalent replacement to the selected components of the present invention and added auxiliary components, and choice of specific embodiments will all fall into the scope protected and disclosed by the present invention.

The above description describes the preferred embodiments of the present invention in detail. However, the present invention is not limited to the specific details in the above embodiments. Simple variants of the technical solutions of the present invention can be made within the scope of the technical conception of the present invention, and these simple variants all fall into the scope of the present invention.

It also needs to be noted that each specific technical feature described in the above embodiments can be combined in any suitable manner in the case of non-contradiction. In order to avoid unnecessary repetition, the present invention does not make further description for various possible combinations.

In addition, any combination of the various embodiments of the present invention can also be made and should be deemed as a disclosure of the present invention, as long as it is not contrary to the thought of the invention.

1. A process for waste heat grading cyclic utilization and pollutant emission reduction of sintering flue gas comprising:
dividing the sintering flue gas into low-temperature, high-oxygen, low-humidity section sintering flue gas, middle-temperature, low-oxygen, high-humidity section sintering flue gas and high-temperature, high-oxygen, low-humidity section sintering flue gas;
conducting the low-temperature, high-oxygen, low-humidity section sintering flue gas into a sintering machine for hot air ignition and hot air sintering;
discharging the middle-temperature, low-oxygen, high-humidity section sintering flue gas after desulfurization treatment;
and mixing the high-temperature, high-oxygen, low-humidity section sintering flue gas with waste gas of a cooler and then conducting said mixture into the sintering machine for hot air sintering.

2. The process of claim 1, further comprising adjusting the ratio of sintering raw materials, fabric thickness, throttle opening of the air exhauster and operating speed of the sintering machine, and adjusting the temperature, oxygen and humidity distributions of the sintering flue gas in the sintering machine by calculating each heat income and expenditure during the sintering process and establishing CFD dynamic heat transfer model, thereby dividing the sintering flue gas into low-temperature, high-oxygen, low-humidity section sintering flue gas, middle-temperature, low-oxygen, high-humidity section sintering flue gas and high-temperature, high-oxygen, low-humidity section sintering flue gas.

3. The process of claim 1, further comprising conducting the low-temperature, high-oxygen, low-humidity section sintering flue gas into the sintering machine after dust removal treatment for hot air ignition and hot air sintering.

4. The process of claim 1, further comprising discharging the middle-temperature, low-oxygen, high-humidity section sintering flue gas after dust removal and desulfurization treatment and SO₂ content thereof.

5. The process of claim 1, further comprising mixing the high-temperature, high-oxygen, low-humidity section sintering flue gas with exhaust gas of the cooler after dust removal treatment.

6. The process of claim 1, wherein the temperature of the low-temperature, high-oxygen, low-humidity section sintering flue gas is 50-100° C.; the temperature of the middle-temperature, low-oxygen, high-humidity section sintering flue gas is 100-250° C.; and the temperature of the high-temperature, high-oxygen, low-humidity section sintering flue gas is 250-350° C.

7. The process of claim 1, wherein the oxygen content of the low-temperature, high-oxygen, low-humidity section sintering flue gas is 18-21%; the oxygen content of the middle-temperature, low-oxygen, high-humidity section sintering flue gas is 11-15%; and the oxygen content of the high-temperature, high-oxygen, low-humidity section sintering flue gas is 18-21%.

8. The process of claim 1, wherein the humidity of the low-temperature, high-oxygen, low-humidity section sintering flue gas is 0-4%; the humidity of the middle-temperature, low-oxygen, high-humidity section sintering flue gas is 4-10%; and the humidity of the high-temperature, high-oxygen, low-humidity section sintering flue gas is 0-4%.

9. The process of claim 1, wherein the exhaust gas of the cooler mixed with the high-temperature, high-oxygen, low-humidity section sintering flue gas represents 25-35% by volume of the total amount of the exhaust gas of the cooler.

10. The process of claim 1, wherein the high-temperature, high-oxygen, low-humidity section sintering flue gas introduced into the sintering machine represents 15-25% by volume of the total amount of the sintering flue gas.

11. The process of claim 1, wherein the low-temperature, high-oxygen, low-humidity section sintering flue gas introduced into the sintering machine represents 15-25% by volume of the total amount of the sintering flue gas.

12. A system for processing waste heat grading cyclic utilization and pollutant emission reduction of sintering flue gas of claim 1, comprising a sintering machine, the bellows of which are divided into low-temperature, high-oxygen, low-humidity section bellows, middle-temperature, low-oxygen, high-humidity section bellows and high-temperature, high-oxygen, low-humidity section bellows, wherein the low-temperature, high-oxygen, low-humidity section bellows are connected to an ignition furnace of the sintering machine and a sealing hot air cover of the sintering machine; the middle-temperature, low-oxygen, high-humidity section bellows are connected to a desulfurization device; and the high-temperature, high-oxygen, low-humidity section bellows are connected to the sealing hot air cover of the sintering machine through a mixing chamber which is further connected to a cooler.

13. The system of claim 12, wherein the low-temperature, high-oxygen, low-humidity section bellows are connected to the ignition furnace of the sintering machine and the sealing hot air cover of the sintering machine after being connected to a dust removal device.

14. The system of claim 12, wherein the middle-temperature, low-oxygen, high-humidity section bellows are connected to a desulfurization device and a chimney successively after being connected to a dust removal device.

15. The system of claim 12, wherein the high-temperature, high-oxygen, low-humidity section bellows are connected to a mixing chamber after being connected to a dust removal device.

16. The system of claim 12, wherein the dust removal device is any one of a cyclone deduster, a bag filter or an electric bag filter, or a combination of at least two of them.

17. The system of claim 12, wherein the desulfurization device is any one of a circulating fluidized bed semi-dry desulfurization device, a SDA desulfurization device or a wet desulfurization device, or a combination of at least two of them.

18. The system of claim 12, wherein a hood is respectively set at both the head and tail of the sintering machine, and the sealing mode thereof is a negative pressure labyrinth seal.
